(19) United States
(12) Patent Application Publication
(10) Pub. No.: US 2018/0096452 A1
(43) Pub. Date: Apr. 5, 2018

(54) IMAGE PROCESSING APPARATUS AND CONTROL METHOD THEREOF

(71) Applicant: SAMSUNG ELECTRONICS CO., LTD., Suwon-si (KR)

(72) Inventor: Ho Seon KIM, Suwon-si (KR)

(73) Assignee: SAMSUNG ELECTRONICS CO., LTD., Suwon-si (KR)

(21) Appl. No.: 15/710,302

(22) Filed: Sep. 20, 2017

(30) Foreign Application Priority Data
Sep. 30, 2016 (KR) 10-2016-0126977

(51) Int. Cl. G06T 3/00; G06T 7/11; G06T 11/40; G06T 7/55; G06T 7/62

(52) U.S. Cl. CPC G06T 3/0087; G06T 7/11; G06T 3/0062; G06T 11/40; G06T 2207/20104; G06T 7/62; G06T 2207/10004; G06T 2207/20221; G06T 7/55

(57) ABSTRACT

An image processing apparatus and a control method thereof are provided. The image processing apparatus includes a memory storing instructions; a processor configured to execute the instructions to: select a region as a stitching target from a plurality of segmented images obtained by segmenting and photographing an object in a plurality of directions, and stitch a boundary of the selected region of the plurality of segmented images to generate a panorama image.

CROSS-REFERENCE TO RELATED APPLICATION(S)

This application claims priority from Korean Patent Application No. 10-2016-0126977, filed on Sep. 30, 2016 in the Korean Intellectual Property Office, the entire disclosure of which is hereby incorporated by reference.

### BACKGROUND

### Field

Apparatuses and methods consistent with the present disclosure relate to an image processing apparatus and a control method thereof, for stitching selected regions of segmented images to generate a panorama image.

### Description of the Related Art

Virtual reality refers to a specific environment or situation that is similar to reality but is not reality, which is formed via an artificial technology using an electronic device. A user feels sensations by a sensory organic via virtual reality and interacts with virtual reality to have sensory experience similar to reality.

As mobile devices such as smart phones and tablet personal computers (PCs) have been generalized, a virtual reality technology has been diversified and easily accessed. Recently, as wearable devices have been commercially available, research has been actively conducted into a virtual reality technology.

A wearable device for implementing virtual reality is a head mounted wearable device such as a head mounted display (HMD). The HMD may provide a see-closed type image for providing virtual reality. An image for implementing virtual reality may be formed by photographing an object in all directions.

### SUMMARY

Example embodiments address and/or overcome the above needs, problems and/or disadvantages and other needs, problems and/or disadvantages not described above. Also, an example embodiment is not required to address and/or overcome the needs, problems and/or disadvantages described above, and an example embodiment may not address or overcome any of the needs, problems and/or disadvantages described above.

When an object is segmented and photographed in all directions and a plurality of segmented images are stitched to generate a panorama image, the plurality of segmented images that contain a region including an object that is not desired by a user or a region that is not to be displayed on a display are stitched and, thus, a desired image of the user may not be displayed on the display in real time.

Aspects of the present disclosure are to address at least the above-mentioned problems and/or disadvantages and to provide at least the advantages described below. Accordingly, an aspect of the present disclosure is to provide an image processing apparatus and a control method thereof, for effectively stitching a plurality of segmented images to generate a panorama image.

In accordance with an aspect of an example embodiment, an image processing apparatus includes a memory storing instructions; a processor configured to execute the instructions to: select a region as a stitching target from a plurality of segmented images obtained by segmenting and photographing an object in a plurality of directions, and stitch a boundary of the selected region of the plurality of segmented images to generate a panorama image.

In accordance with another aspect of the present disclosure, a method of controlling an image processing apparatus includes selecting a region as a stitching target from a plurality of segmented images obtained by segmenting and photographing an object in in a plurality of directions, and stitching a boundary of the selected region of the plurality of segmented images to generate a panorama image

In accordance with another aspect of the present disclosure, a computer readable recording medium has recorded thereon a program which is executable by a computer to perform a method including selecting a region as a stitching target from a plurality of segmented images obtained by segmenting and photographing an object in a plurality of directions, and stitching a boundary of the selected region of the plurality of segmented images to generate a panorama image.

### BRIEF DESCRIPTION OF THE DRAWINGS

The above and other aspects will be more apparent from the following description of example embodiments taken in conjunction with the accompanying drawings, in which:

FIG. 1 is a diagram illustrating a virtual reality system according to various example embodiments;

FIG. 2 is a block diagram illustrating a structure of an image processing apparatus according to various example embodiments;

FIG. 3 is a block diagram illustrating a structure of a processor of an image processing apparatus according to various example embodiments;

FIGS. 4A and 4B are diagrams illustrating a plurality of segmented images according to an example embodiment;

FIGS. 5A and 5B are diagrams illustrating an omnidirectional image according to an example embodiment;

FIGS. 6A and 6B are diagrams illustrating a plurality of segmented images according to an example embodiment;

FIGS. 7A and 7B are diagrams illustrating an omnidirectional image according to an example embodiment;

FIG. 8 is a diagram illustrating an image displayed on a display according to various example embodiments; and

FIG. 9 is a flowchart of a method of controlling an image processing apparatus according to various example embodiments.

### DETAILED DESCRIPTION

The present disclosure will now be described more fully with reference to the accompanying drawings, in which example embodiments are shown. However, this is not intended to limit the present disclosure to particular modes of practice, and it is to be appreciated that all modification, equivalents, and alternatives that do not depart from the spirit and technical scope of the present disclosure are encompassed in the present disclosure. With regard to the description of the drawings, the same reference numerals denote like elements.

In this disclosure, the expressions “have”, “may have”, “include” and ^{“}comprise”, or “may include” and “may comprise” used herein indicate existence of corresponding features (e.g., elements such as numeric values, functions, operations, or components) but do not exclude presence of additional features.

In this disclosure, the expressions “A or B”, “at least one of A or/and B”, or ^{“}one or more of A or/and B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used in this disclosure may be used to refer to various elements regardless of the order and/or the priority and to distinguish the relevant elements from other elements, but do not limit the elements. For example, “a first user device” and “a second user device” indicate different user devices regardless of the order or priority. For example, without departing the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used in this disclosure may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device.

Terms used in this disclosure are used to describe specified embodiments and are not intended to limit the scope of another embodiment. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal unless expressly so defined in various embodiments of this disclosure. In some cases, even if terms are terms which are defined in this disclosure, they may not be interpreted to exclude embodiments of this disclosure.

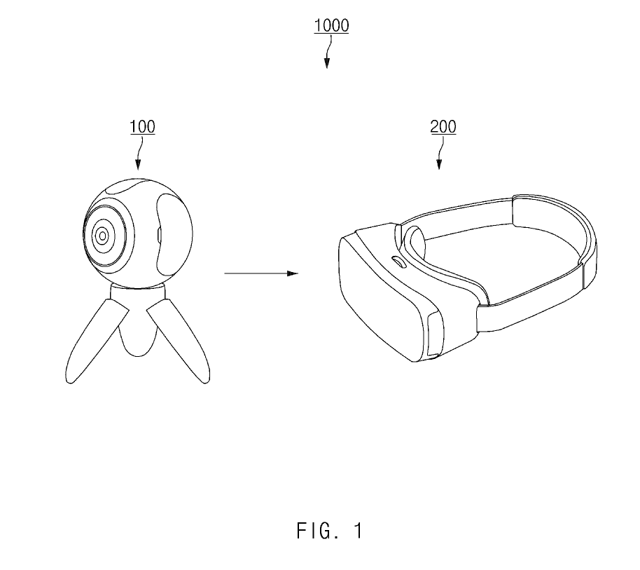

FIG. 1 is a diagram illustrating a virtual reality system according to various example embodiments.

Referring to FIG. 1, a virtual reality system 1000 may include a camera apparatus 100 and an image processing apparatus 200.

The camera apparatus 100 may photograph an object in all directions with respect to the camera apparatus 100 to generate images. For example, the camera apparatus 100 may include a plurality of optical modules. The plurality of optical modules may segment and photograph the object in all directions at specific angles. Photography ranges of the plurality of optical modules may, for example, partially overlap each other. The photography ranges may partially overlap each other such that the camera apparatus 100 stably photographs the object in all directions. Accordingly, the camera apparatus 100 may segment and photograph the object in all directions to generate a plurality of segmented images.

According to an example embodiment, the images obtained by segmenting and photographing an object by the camera apparatus 100 may be spherical segmented images. For example, the spherical segmented images may be spread to form planar segmented images. The planar segmented images may be stitched to form a panorama image.

According to an example embodiment, the camera apparatus 100 may transmit the plurality of segmented images to the image processing apparatus 200. For example, the camera apparatus 100 may transmit the plurality of segmented images to the image processing apparatus 200 through a wireless communication interface that includes, e.g., a wireless-fidelity (Wi-Fi) module, a Bluetooth module, and/or a near field communication (NFC) module. As another example, the camera apparatus 100 may transmit the plurality of segmented images to the image processing apparatus 200 through a wired communication interface that includes, e.g., a universal asynchronous receiver/transmitter (UART) module, an RS232 module, and a serial peripheral interconnect (SPI) module.

The image processing apparatus 200 may receive the plurality of planar segmented images from the camera apparatus 100 to generate one panorama image. For example, the image processing apparatus 200 may spread the plurality of spherical segmented images to generate a plurality of planar segmented images. The image processing apparatus 200 may stitch boundaries of the plurality of planar segmented images formed by photographing an object in all directions to generate one panorama image.

According to an example embodiment, the image processing apparatus 200 may select regions as a stitching target from the plurality of planar segmented images and may generate a planar panorama image. For example, the image processing apparatus 200 may select and stitch regions obtained by excluding specific regions of the plurality of planar segmented images. As another example, the image processing apparatus 200 may select and stitch partial regions of the plurality of planar segmented images, based on regions of the plurality of planar segmented images, which are to be displayed on a display.

According to an example embodiment, the image processing apparatus 200 may change the planar panorama image to a spherical panorama image. The image processing apparatus 200 may receive a user input or may detect user movement, may select a partial region of the spherical panorama image, and may display the selected region on a display. For example, the image processing apparatus 200 may be a wearable device (e.g., a head mounted display (HMD) which is wearable by a user.

According to an example embodiment, the image processing apparatus 200 may arrange panorama images in a time sequence to generate a video image. The panorama image may constitute a frame of the video image. The image processing apparatus 200 may display a selected region from the panorama image constituting the frame of the video image on a display.

According to an example embodiment, the virtual reality system 1000 may include a separate display apparatus. The display apparatus may receive a panorama image from an external apparatus and may display the selected region from the received panorama image on the display. For example, the display apparatus may receive the panorama image generated by the image processing apparatus 200. The generated panorama image may be, for example, a planar panorama image. As another example, the display apparatus may receive the panorama image generated from the camera apparatus 100. For example, the camera apparatus 100 may generate the panorama image in the same way as the image processing apparatus 200 and transmit the generated panorama image to the display apparatus.

Accordingly, the virtual reality system 1000 may process a plurality of segmented images captured by the camera apparatus 100 via the image processing apparatus 200 to generate a panorama image and may display a portion of the panorama image on the display to implement virtual reality.

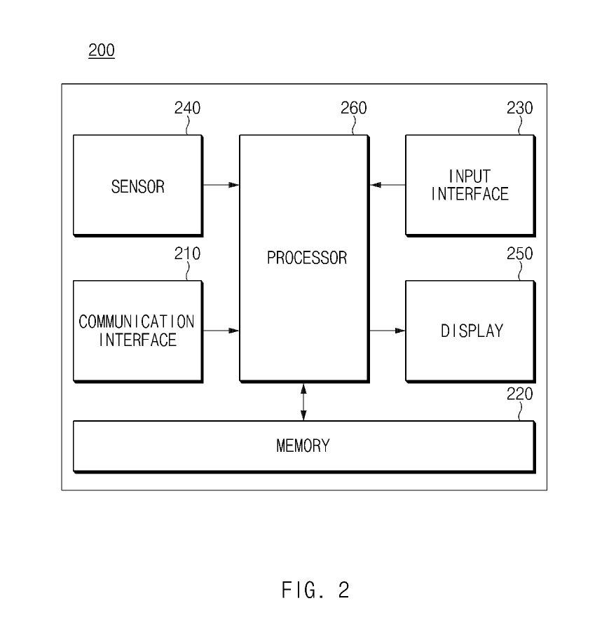

FIG. 2 is a block diagram illustrating a structure of an image processing apparatus according to various example embodiments.

Referring to FIG. 2, the image processing apparatus 200 may include a communication interface 210, a memory 220, an input interface 230, a sensor 240, a display 250, and a processor 260.

The communication interface 210 may include at least one of a wireless communication interface and a wired communication interface. The communication interface 210 may be connected to the camera apparatus 100 by wire or wirelessly and may receive a plurality of segmented images. For example, the wireless communication interface may be wirelessly connected to the camera apparatus 100 and may receive a plurality of spherical segmented images. The wireless communication interface may include, for example, a Wi-Fi module, a Bluetooth module, or an NFC module. As another example, the wired communication interface may be connected to the camera apparatus 100 by wire. The wired communication interface may include, for example, a UART module, an RS232 module, or an SPI module.

The memory 220 may store information for selection of regions as a stitching target from a plurality of segmented images. For example, the information for selection of the regions as a stitching target may include information for selection of specific regions from the plurality of planar segmented images. The memory 220 may be, for example, a non-volatile memory such as a flash memory and a hard disk.

The input interface 230 may generate input information of a user. The user may input selection of a region of the panorama image, which is to be displayed on the display 250, thorough the input interface 230. The panorama image may be, for example, a planar panorama image. The input interface 230 may generate information corresponding to the user input.

The sensor 240 may detect user movement. For example, the sensor 240 may be a motion sensor for detection of the user movement.

According to an example embodiment, the sensor 240 may detect user movement to select a region of the planar panorama image, which is to be displayed on the display 250. The sensor 240 may generate information corresponding to the user movement. For example, the sensor 240 may detect a direction in which the front of the user's head is moved to generate information corresponding to the moving direction.

According to an example embodiment, the sensor 240 may detect user movement to select regions as a stitching target from a plurality of planar segmented images. The sensor 240 may generate information corresponding to the user movement. For example, the sensor 240 may detect the speed and direction of the user movement to generate information corresponding to the speed and direction of the user movement.

The display 250 may display the selected region of the panorama image. The selected region of the panorama image may be a partial region of the spherical panorama image, which is selected based on information generated via the input interface 230 and the sensor 240.

The processor 260 may control an overall operation of the image processing apparatus 200. For example, the processor 260 may control the communication interface 210, the memory 220, the input interface 230, the sensor 240, and the display 250 to generate a panorama image formed by stitching the selected regions of the plurality of segmented images and may display the selected region of the generated panorama image on the display 250.

According to an example embodiment, the image processing apparatus 200 may include at least one processor 260. For example, the image processing apparatus 200 may include a plurality of processors 260 that are capable of performing at least one function.

According to an example embodiment, the processor 260 may be implemented with a system on chip (SoC) including a central processing unit (CPU), a graphic processing unit (GPU), a memory, and so on.

According to an example embodiment, the virtual reality system 1000 of FIG. 1 may include a separate display apparatus. For example, the display apparatus may receive a panorama image from the image processing apparatus 200, may receive a user input or may detect user movement, and may display the selected region of the received panorama image on a display. The display apparatus may generate the user input information or may detect the user movement and may select a region displayed on the display from the panorama image. The image processing apparatus 200 may receive, for example, information on a region to be displayed on the display through the communication interface 210.

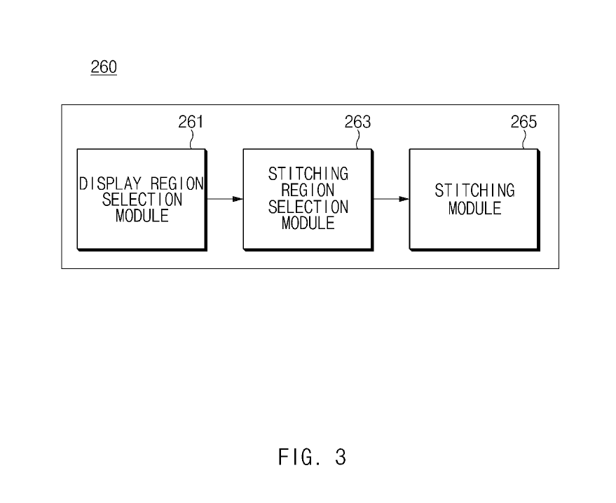

FIG. 3 is a block diagram illustrating a structure of a processor of an image processing apparatus according to various example embodiments.

Referring to FIG. 3, the processor 260 may include a display region selection module 261, a stitching region selection module 263, and a stitching module 265.

The display region selection module 261 may select a region to be displayed on the display 250 from the spherical panorama image. For example, the display region selection module 261 may receive information corresponding to a user input from the input interface 230 and may select a region to be displayed on the display 250 from the spherical panorama image based on the user input. As another example, the display region selection module 261 may receive information corresponding to user movement from the sensor 240 and may select the region to be displayed on the display 250 from the spherical panorama image based on the user movement.

According to an example embodiment, the display region selection module 261 may generate information on the region to be displayed on the display 250 from the spherical panorama image. The display region selection module 261 may transmit information on the region to be displayed on the display 250 to the stitching region selection module 263.

The stitching region selection module 263 may spread the plurality of spherical segmented images received from the camera apparatus 100 to change the plurality of spherical segmented images to a plurality of planar segmented images.

According to an example embodiment, the stitching region selection module 263 may select regions as a stitching target from the plurality of planar segmented images. The stitching region selection module 263 may transmit the regions selected as a stitching target from the plurality of planar segmented images to the stitching module 265.

For example, the stitching region selection module 263 may receive information for selection of a region as a stitching target from the memory 220 and may select the region as a stitching target based on the received information. The information on the region as a stitching target may include, for example, information on specific regions of the plurality of planar segmented images. The specific regions may be obtained by excluding a region corresponding to a specific region of a lower end portion of the panorama image.

As another example, the stitching region selection module 263 may receive information on a region to be displayed on the display 250 from the display region selection module 261 and select the region as a stitching target based on the received information. The region as a stitching target may be selected as the region to be displayed on the display 250 and an adjacent specific region to the region to be displayed on the display 250. The adjacent specific region may be, for example, a specific region that is selected without consideration of user movement. As another example, the adjacent specific region may be determined based on the user movement information received from the sensor 240. The user movement information may be information on the speed and direction of a user and the stitching region selection module 263 may determine at least one of a shape and a size of the specific region based on the speed and direction of the user. The stitching region selection module 263 may determine the size of the specific region in proportion to the speed of the user movement.

The stitching module 265 may stitch the selected regions of the plurality of planar segmented images to generate a planar panorama image. The processor 260 may change the planar panorama image to a spherical panorama image. The display region selection module 261 may select a region of the spherical panorama image, displayed on the display 250.

Accordingly, the processor 260 may select the regions as a stitching target from the plurality of segmented images and may stitch the selected regions of the plurality of segmented images to generate a panorama image.

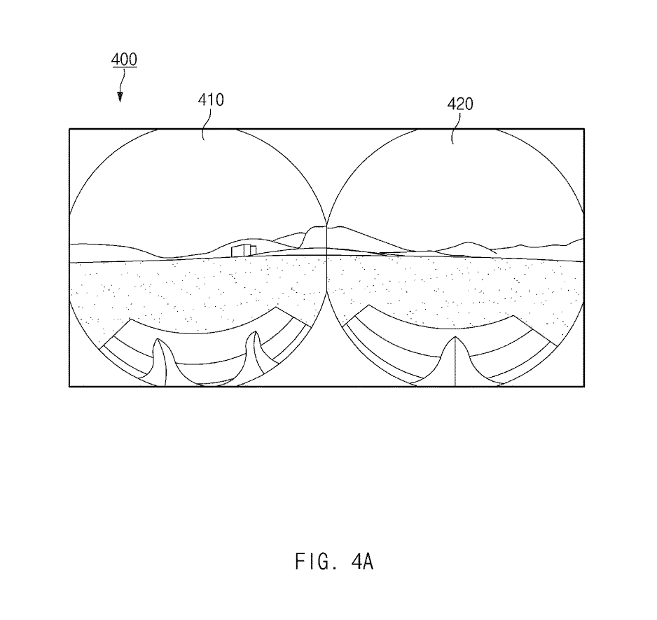

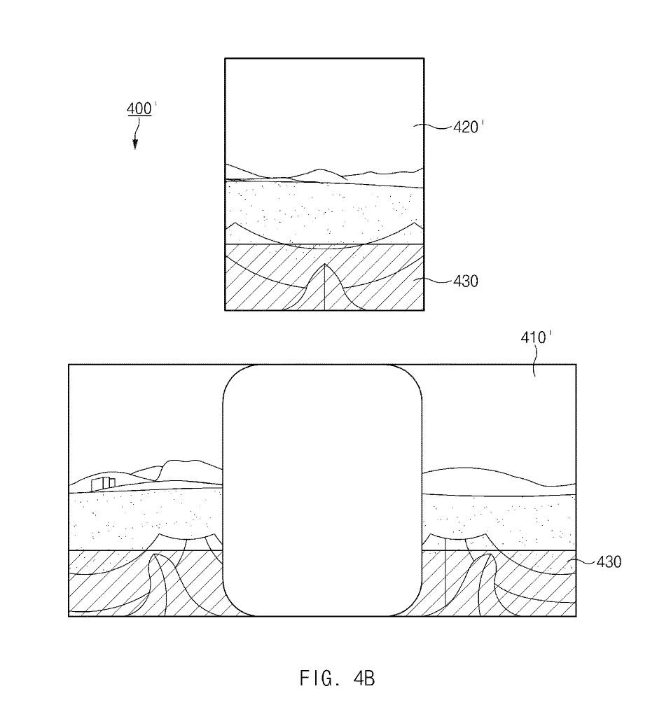

FIGS. 4A and 4B are diagrams illustrating a plurality of segmented images according to an example embodiment.

Referring to FIG. 4A, the camera apparatus 100 may photograph an object in all directions to generate a plurality of spherical segmented images 400. For example, the camera apparatus 100 may include a first optical module and a second optical module and the first optical module and the second optical module may generate a first spherical segmented image 410 and a second spherical segmented image 420, respectively.

Referring to FIG. 4B, the image processing apparatus 200 may receive the plurality of spherical segmented images 400 and spread the plurality of spherical segmented images 400 to generate a plurality of planar segmented images 400′. For example, the plurality of planar segmented images 400′ may include a first planar segmented image 410′ and a second planar segmented image 420′.

According to an example embodiment, the image processing apparatus 200 may select specific regions as a stitching target from the plurality of planar segmented images 400′. For example, the image processing apparatus 200 may receive information on a specific region from the memory 220. The specific region may be, for example, a region of a displayed image formed by photographing a support of the camera apparatus 100. The region of the displayed image formed by photographing the support of the camera apparatus 100 may be a lower end portion 430 of each of the first planar segmented image 410′ and the second planar segmented image 420′. Accordingly, the image processing apparatus 200 may select a region obtained by excluding the lower end portion 430 from each of the first planar segmented image 410′ and the second planar segmented image 420′ as the specific region.

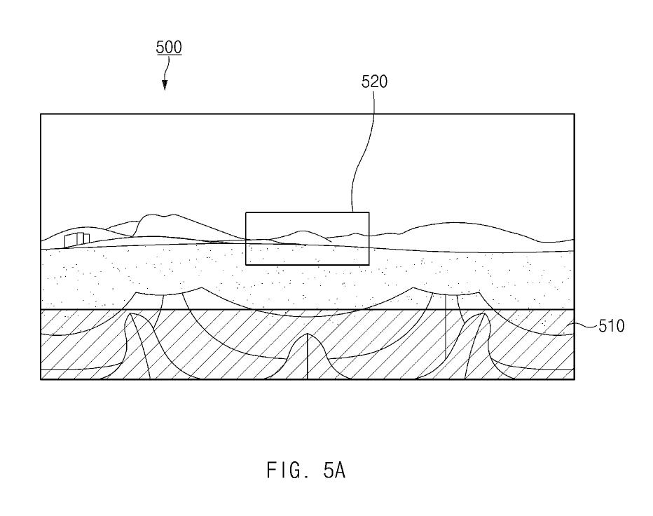

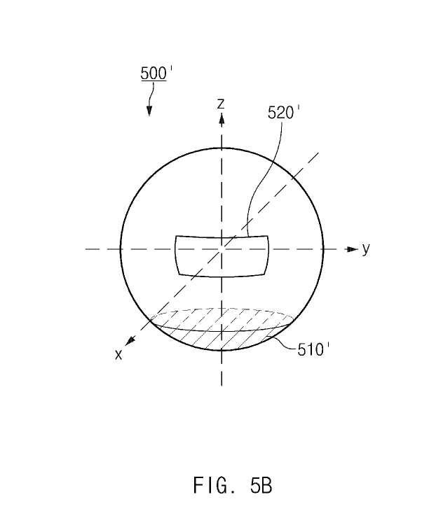

FIGS. 5A and 5B are diagrams illustrating an omnidirectional image according to an example embodiment.

Referring to FIG. 5A, the image processing apparatus 200 may stitch the regions selected from the first planar segmented image 410′ and the second planar segmented image 420′ to form a planar panorama image 500. For example, the image processing apparatus 200 may stitch a region obtained by excluding a specific region of the planar panorama image 500. The specific region may be, for example, a lower end portion 510 of the planar panorama image 500, formed by photographing a support of the camera apparatus 100. The lower end portion 510 of the planar panorama image 500 may correspond to the lower end portion 430 of each of the first planar segmented image 410′ and the second planar segmented image 420′.

According to an example embodiment, the planar panorama image 500 may include a region 520 to be displayed on the display 250. The region 520 to be displayed on the display 250 may be selected based on user input information or user movement information.

Referring to FIG. 5B, the image processing apparatus 200 may change the planar panorama image 500 to a spherical panorama image 500′. For example, a specific region of the spherical panorama image 500′ may not be stitched. The specific region may be, for example, a lower end portion 510′ of the spherical panorama image 500′. The lower end portion 510′ of the spherical panorama image 500′ may correspond to the lower end portion 510 of the planar panorama image 500.

According to an example embodiment, the image processing apparatus 200 may select a region 520′ to be displayed on the display 250 from the spherical panorama image 500′. For example, the image processing apparatus 200 may select the region 520′ to be displayed on display 250 based on the user input information or the user movement information.

Accordingly, the image processing apparatus 200 may select specific regions from the plurality of planar segmented images 400′ in all cases and may stitch the selected regions to form the panorama images 500 and 500′.

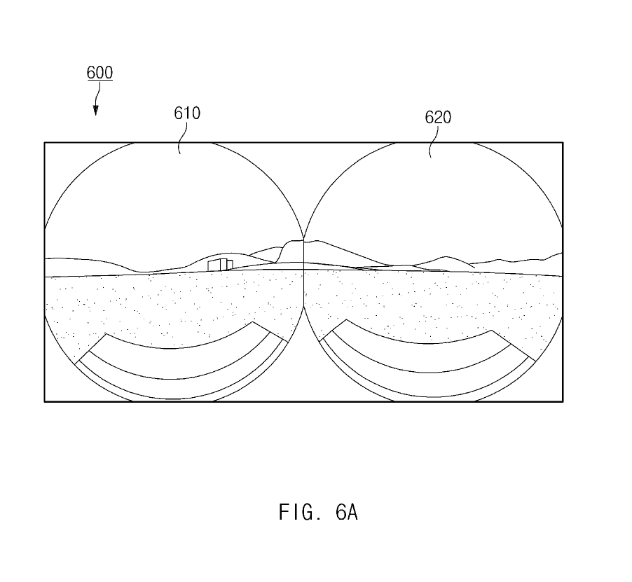

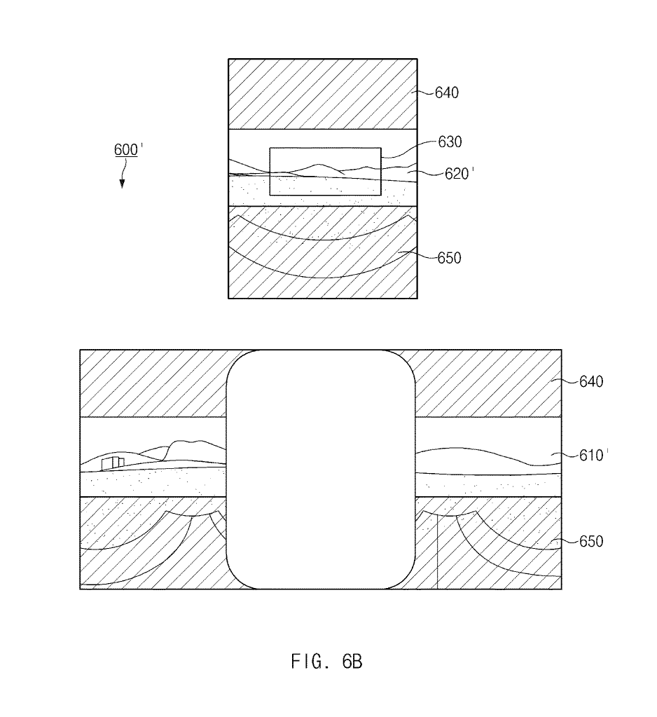

FIGS. 6A and 6B are diagrams illustrating a plurality of segmented images according to an example embodiment.

Referring to FIG. 6A, the camera apparatus 100 may photograph an object in all directions to generate a plurality of spherical segmented images 600. The camera apparatus 100 may include a first optical module and a second optical module and the first optical module and the second optical module may generate a first spherical segmented image 610 and a second spherical segmented image 620, respectively.

Referring to FIG. 6B, the image processing apparatus 200 may receive the plurality of spherical segmented images 600 and may spread the plurality of spherical segmented images 600 to generate a plurality of planar segmented images 600′. For example, the plurality of planar segmented images 600′ may include a first planar segmented image 610′ and a second planar segmented image 620′.

According to an example embodiment, the image processing apparatus 200 may select a region as a stitching target based on information on a region 630 to be displayed on the display 250. For example, the image processing apparatus 200 may select a region to be displayed on the display 250 and a specific region adjacent to the region 630 to be displayed on the display 250 from the plurality of planar segmented images 600′. The specific region may be, for example, a region selected without consideration of user movement. The specific region may be, as another example, a region selected based on user movement. Accordingly, the image processing apparatus 200 may select a region excluding an upper end portion 640 and a lower end portion 650 of each of the first planar segmented image 610′ and the second planar segmented image 620′ as a region to be stitched.

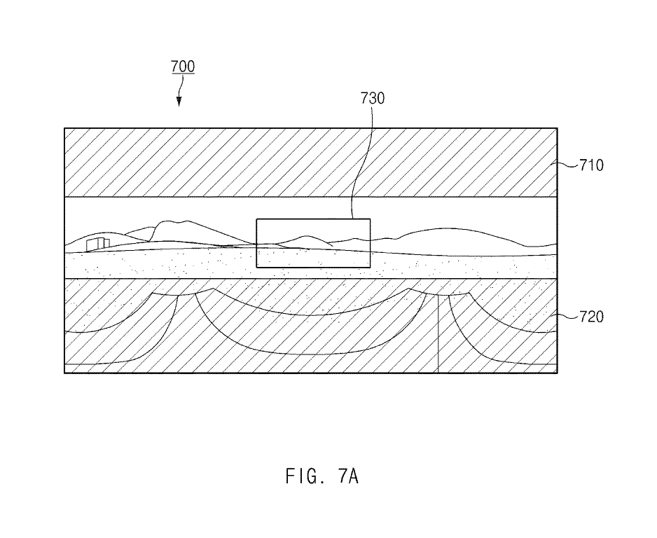

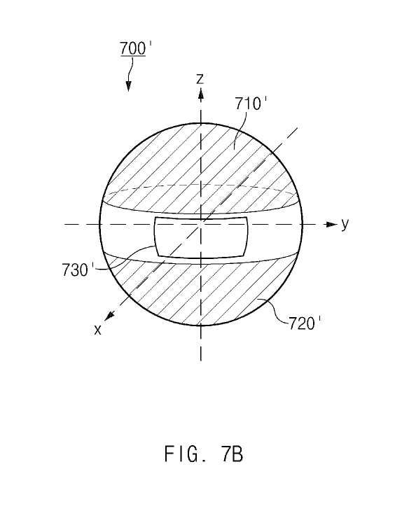

FIGS. 7A and 7B are diagrams illustrating an omnidirectional image according to an example embodiment.

Referring to FIG. 7A, the image processing apparatus 200 may stitch the selected regions from the first planar segmented image 610′ and the second planar segmented image 620′ to form a planar panorama image 700. For example, the image processing apparatus 200 may stitch a region obtained by excluding a specific region of the planar panorama image 700. The specific region may be, for example, an upper end portion 710 and a lower end portion 720 of the planar panorama image 700. The upper end portion 710 and the lower end portion 720 of the planar panorama image 700 may respectively correspond to the upper end portion 640 and the lower end portion 650 of each of the first planar segmented image 610′ and the second planar segmented image 620′.

According to an example embodiment, the planar panorama image 700 may include a region 730 to be displayed on the display 250. The region 730 to be displayed on the display 250 may be selected based on user input information or user movement information.

Referring to FIG. 7B, the planar panorama image 700 may be changed to a spherical panorama image 700′. For example, a specific region of the spherical panorama image 700′ may not be stitched. The specific region may be, for example, an upper end portion 710′ and a lower end portion 720′ of the spherical panorama image 700′. The upper end portion 710′ and the lower end portion 720′ of the spherical panorama image 700′ may correspond to the upper end portion 710 and the lower end portion 720 of the planar panorama image 700, respectively.

According to an example embodiment, the image processing apparatus 200 may select a region 720′ to be displayed on the display 250 from the spherical panorama image 700′. For example, the image processing apparatus 200 may select the region 720′ to be displayed on the display 250 based on user input information or user movement information.

Accordingly, the image processing apparatus 200 may select the region 630 to be displayed on the display 250 and a specific region adjacent to the region 630 to be displayed on the display 250 from the plurality of planar segmented images 600′ and may stitch the selected regions to form the panorama images 700 and 700′.

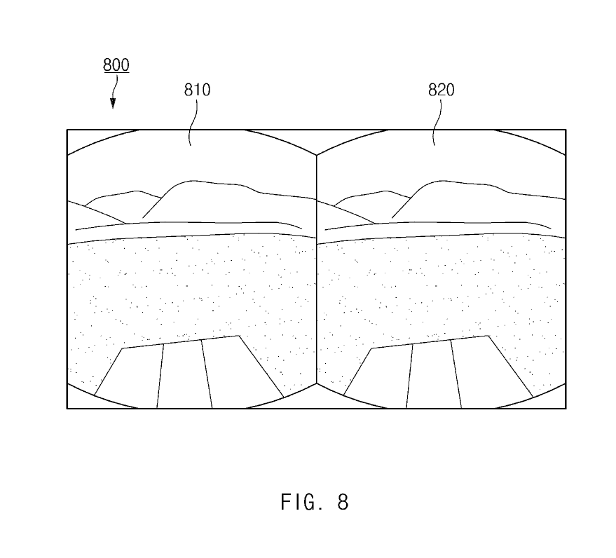

FIG. 8 is a diagram illustrating an image displayed on a display according to various example embodiments.

Referring to FIG. 8, the image processing apparatus 200 may display a plurality of display images 800 selected from a spherical panorama image based on user input information or user movement information, on the display 250. The plurality of display images 800 may include a first display image 810 and a second display image 820. The first display image 810 and the second display image 820 may be similar or may be different depending on user view.

According to the various example embodiments described with reference to FIGS. 1 to 8, the image processing apparatus 200 may select regions as a stitching target from a plurality of segmented images generated from the camera apparatus 100 and may stitch the selected region of the plurality of segmented images to effectively generate a panorama image and, thus, may display a region of the panorama image, desired by a user, on the display 250 in real time.

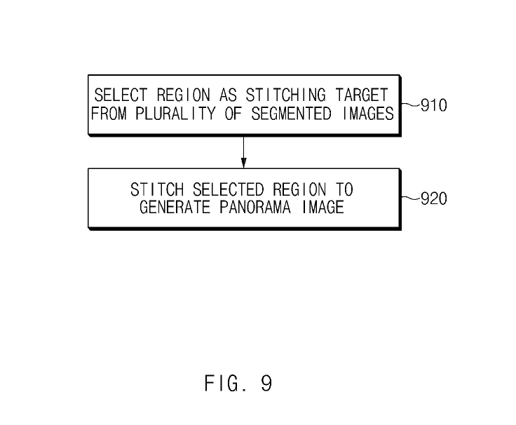

FIG. 9 is a flowchart of a method of controlling an image processing apparatus according to various example embodiments.

The flowchart of FIG. 9 may include operations processed by the aforementioned image processing apparatus 200 and may illustrates a method of controlling the image processing apparatus 200 for generating a panorama image. Accordingly, although omitted below, the above description of the image processing apparatus 200, which has been given with reference to FIGS. 1 to 8, may be applied to the flowchart of FIG. 9.

According to an example embodiment, in operation 910, the image processing apparatus 200 may select regions as a stitching target from a plurality of segmented images. For example, the image processing apparatus 200 may select a specific region from the plurality of segmented images. As another example, the image processing apparatus 200 may select regions as a stitching target from the plurality of segmented images based on a region of a panorama image, to be displayed on the display 250. The image processing apparatus 200 may select, for example, a region to be displayed on the display 250 and a specific region adjacent to the region to be displayed on the display 250. The image processing apparatus 200 may detect user movement and may determine the specific region or may receive a user input and may determine the specific region. As another example, the image processing apparatus 200 may receive information on a region to be displayed on a display from an external apparatus and may select a partial region from the plurality of segmented images based on the received information.

According to an example embodiment, in operation 920, the image processing apparatus 200 may stitch boundaries of selected regions of the plurality of segmented images to generate a panorama image.

In the specification, the term “module” may refer to, for example, a unit including one or two or more combinations of hardware, software, and firmware. The term “module” may be interchangeably used with, for example, terms such as “unit”, “logic”, “logical block”, “component”, or “circuit”. The “module” may refer to a minimum unit of an integrally configured element or a portion thereof. The “module” may refer to a minimum unit for performing one or more functions or a portion thereof. The “module” may be mechanically or electrically implemented. For example, the “module” may include at least one of an application-specific integrated circuit (ASIC) chip, field-programmable gate arrays (FPGAs), and a programmable-logic device for performing some operations, which are well known and will be developed in the future and perform specified operations.

At least some of the apparatuses (e.g., modules or functions) or the methods (e.g., operations) according to the various embodiments may be implemented with, for example, instructions stored in a memory, i.e., computer-readable storage media in the form of a program module. When the instructions is executed by one or more processor (e.g., the processor 260), the one or more processors may perform a function corresponding to the instructions.

The computer-readable storage media may include a hard disk, a floppy disk, magnetic media (e.g., a magnetic tape), optical media (e.g., CD-ROM, and digital versatile disk (DVD)), magneto-optical media (e.g., a floptical disk), a hardware device (e.g., ROM, RAM, or flash memory), and so on. In addition, Examples of the program commands include a machine language code created by a compiler and a high-level language code executable by a computer using an interpreter and the like. The aforementioned hardware device may be configured to function as one or more software module so as to perform the operations according to the various embodiments or vice versa.

The module or the program modules according to the various embodiments may include at least one of the aforementioned elements, may exclude some of the elements, or may further include other elements. The operations performed by the modules, the program modules, or other elements according to the various embodiments may be performed using a sequential, parallel, iterative, or heuristic method. In addition, some operations may be performed in a different order, may be omitted, or other operations may be added.

An image processing apparatus and a control method thereof according to the example embodiments may select regions as a stitching target from a plurality of segmented images generated from a camera apparatus and may stitch the selected regions of the plurality of segmented images to effectively generate a panorama image and, thus, may display a region of the panorama image, desired by a user, on a display in real time.

While example embodiments have been shown and described, it will be understood by those skilled in the art that various changes in form and details may be made therein without departing from the spirit and scope of the present disclosure as defined by the appended claims and their equivalents.

What is claimed is:

1. An image processing apparatus comprising:
a memory storing instructions;
a processor configured to execute the instructions to:
select a region as a stitching target from a plurality of segmented images obtained by segmenting and photographing an object in a plurality of directions; and
stitch a boundary of the selected region of the plurality of segmented images to generate a panorama image.

2. The image processing apparatus of claim 1, wherein the plurality of segmented images is a plurality of spherical segmented images,
wherein the processor is configured to execute the instructions to change the plurality of spherical segmented images to a plurality of planar segmented images and to select the region as the stitching target from the plurality of planar segmented images.

3. The image processing apparatus of claim 1, wherein the processor is configured to execute the instructions to select a specific region from the plurality of segmented images.

4. The image processing apparatus of claim 3, wherein the specific region is obtained by excluding a region corresponding to a specific region of a lower end portion of the panorama image from the plurality of segmented images.

5. The image processing apparatus of claim 1, wherein the processor is configured to execute the instructions to select the region as the stitching target from the plurality of segmented images based on a region of the panorama image, to be displayed on a display.

6. The image processing apparatus of claim 5, wherein the processor is configured to execute the instructions to select the region to be displayed on the display and an adjacent specific region that is adjacent to the region to be displayed on the display.

7. The image processing apparatus of claim 6, further comprising:
a sensor configured to detect a user movement; and
a display region selection module configured to select the region to be displayed on the display based on the user movement,
wherein the processor is configured to execute the instructions to determine at least one of a shape and a size of the specific region based on at least one of a speed and a direction of the user movement.

8. The image processing apparatus of claim 7, wherein the processor is configured to execute the instructions to determine the size of the specific region in proportion to the speed of the user movement.

9. The image processing apparatus of claim 5, further comprising an input interface configured to receive a user input,
wherein the processor is configured to execute the instructions to select the region to be displayed on the display based on the user input.

10. The image processing apparatus of claim 1, further comprising:
a communication interface configured to receive information on a region to be displayed on a display from an external apparatus,
wherein the processor is configured to execute the instructions to select the region as the stitching target from the plurality of segmented images based on the information on the region to be displayed on the display.

11. A method of controlling an image processing apparatus, the method comprising:
selecting a region as a stitching target from a plurality of segmented images obtained by segmenting and photographing an object in a plurality of directions; and
stitching a boundary of the selected region of the plurality of segmented images to generate a panorama image.

12. The method of claim 11, wherein the selecting the region as the stitching target comprises:
changing a plurality of spherical segmented images to a plurality of planar segmented images; and
selecting the region as the stitching target from the plurality of planar segmented images.

13. The method of claim 11, wherein the selecting the region as the stitching target comprises selecting a specific region from the plurality of segmented images.

14. The method of claim 11, wherein the selecting the region as the stitching target comprises selecting the region as the stitching target from the plurality of segmented images based on a region of the panorama image, to be displayed on a display.

15. The method of claim 14, wherein the selecting the region based on the region of the panorama image, to be displayed comprises selecting the region to be displayed on the display and an adjacent specific region that is adjacent to the region to be displayed on the display.

16. The method of claim 15, wherein the selecting the adjacent specific region to the region to be displayed comprises:
detecting a user movement; and
determining at least one of a shape and a size of the specific region based on at least one of speed and a direction of the user movement.

17. The method of claim 14, wherein the selecting the region based on the region of the panorama image, to be displayed comprises:
receiving a user input; and
selecting the region to be displayed on the display based on the user input.

18. The method of claim 11, wherein the selecting the region as the stitching target comprises:
receiving information on a region to be displayed on a display from an external apparatus; and
selecting the region as the stitching target from the plurality of segmented images based on the information on the region to be displayed on the display.

19. A computer readable recording medium having recorded thereon a program which is executable by a computer to perform a method comprising:
selecting a region as a stitching target from a plurality of segmented images obtained by segmenting and photographing an object in a plurality of directions; and
stitching a boundary of the selected region of the plurality of segmented images to generate a panorama image.

20. The computer readable recording medium of claim 19, wherein the selecting the region as the stitching target comprises:
changing a plurality of spherical segmented images to a plurality of planar segmented images; and
selecting the region as the stitching target from the plurality of planar segmented images.
